(19) United States
(12) Patent Application Publication
(10) Pub. No.: US 2010/0128676 A1
(43) Pub. Date: May 27, 2010

(54) Carrier Channel Distribution System

(76) Inventors: Dong Wu, Carlsbad, CA (US); Haixin Hu, Cypress, CA (US); Pingsheng MA, Plano, TX (US)

Correspondence Address: FISH & ASSOCIATES, PC;ROBERT D. FISH, 2603 Main Street, Suite 1000, Irvine, CA, 92614-6232, US

(21) Appl. No.: 12/616,700

(22) Filed: Nov. 11, 2009

Related U.S. Application Data
(60) Provisional application No. 61/117,469, filed on Nov. 24, 2008.

(51) Int. Cl. H04W 40/00

(52) U.S. Cl. 370/328

(57) ABSTRACT

Carrier channel distribution systems are presented. Wireless carrier channels can be split from their respective bands and can be allocated among remote transceiver units to ensure proper coverage for wireless services. Carrier channels can be allocated or routed individually or as a group according to reconfigurable routing policy.

This application claims the benefit of priority to U.S. provisional application having Ser. No. 61/117,469 filed on Nov. 24, 2008. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is wireless carrier channel technologies.

### BACKGROUND

Wireless carriers utilize a number of frequency bands to carry voice, or other data, from one location to another. For example, the carriers can utilize bands around 800 MHz, 850 MHz, 900 MHz, 1800 MHz, 1900 MHz, or other frequencies as defined by standards or governing bodies. Commonly used techniques for wireless communication include CDMA, TDMA, or FDMA. Each carrier can utilize one or more carrier channels within the frequency bands to carry voice or other data for their services.

Unfortunately, geography of an area can severely limit the range in which wireless devices can operate and limit the efficiency of distributing the bands over a coverage area. The industry has responded by providing various cell networks to provide coverage for their services. In some deployments, remote transceiver units (RTUs) provide coverage for a cell area. The RTUs communicate with remote a base station, which can forward data in the channels to other locales or can interact with user equipment. The base station can also receive and digitize signals, which can then be forwarded one to the RTUs. Frequently, the RTUs lack wireless line-of-sight to the base stations due to geography. Rather than RTUs and base stations interacting wirelessly, they communicate with each other by digitized data over a backhaul fiber optic link.

Known carrier transport systems comprise terminals that digitize entire bands regardless of the carrier channels within in the band to ensure the terminals can operate with multiple carriers or standards. Such systems offer flexibility, but lack fine grained control over carrier channels, which results in many deficiencies. For example, a backhaul link can become unnecessarily congested because an entire band is digitized as opposed to only active carrier channels. Furthermore, such systems also lack the ability to allocate carrier channels from one cell region to another in response to various events or conditions. As examples, consider the following references describing effort directed toward providing support for carrier channel distribution:
U.S. Pat. No. 5,642,405 to Fischer et al. titled “Cellular Communications Systems with Centralized Base Stations and Distributed Antenna Units”, filed on Aug. 31, 1994, and discusses aspects of digitizing and multiplexing signals within a Mobile Telecommunication Switching Office (MTSO).
U.S. Pat. No. 6,785,558 to Stratford et al. titled “System and Method for Distributing Wireless Communication Signals Over Metropolitan Telecommunication Networks”, filed on Dec. 6, 2002, describes a distributing wireless signal between a base station hotel and remote cell sites using separately digitized RF carrier signals.
U.S. patent application publication 2006/0258305 to Aschermann titled “Method and System for Transmission of Carrier Signals Between First and Second Antenna Networks” filed Jan. 30, 2002, discusses aspects of switching carrier signals among antenna networks.

A better carrier channel transport system would allow fine grained control over carrier channels from a single band or multiple bands by splitting carrier channels from their bands and routing the channels to RTUs as desired through a matrix switch according to a routing policy, possibly where the routing policy can be updated or reconfigured as desired.

Thus, there is still a need for a carrier channel distribution system.

### SUMMARY OF THE INVENTION

The inventive subject matter provides apparatus, systems and methods in which a carrier channel distribution system can route individual carrier channels to Remote Transceiver Units (RTUs). The carrier channels can be routed according to a routing policy that can be reconfigured as desired. One aspect of the inventive subject matter includes a system comprising one or more multi-band transceivers configured to receive one or more frequency bands. Preferred frequency bands comprises more than one carrier channel per band. The contemplated system can also include a matrix switch in electrical bi-direction communication with the multi-band transceiver. The matrix switch can be configured to receive analog carrier channels and can include a combiner/splitter to separate out individual carrier channels from their respective bands. The switch preferably routes the individual channels, individually or combined, to RTUs according to a routing policy. The routing policy can be reconfigured as desired or can operate according to a priori defined rules based on circumstances including weather, events, traffic load, load balance, or other circumstances.

RTUs can be configured to distribute the carrier channels many different ways. In some embodiments, RTUs can be configured into a simulcast configuration where a host unit distributes the same carrier channels to multiple RTUs. In other embodiments, RTUs can be configured into a cascade configuration where a host unit distributes a carrier channel to a first RTU, which then forwards the carrier channel to another RTU.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a carrier channel distribution system.

FIG. 2 is a schematic of a possible base transceiver station (BTS) having a matrix switch and host units.

FIG. 3 is a schematic of a possible remote transceiver unit (RTU).

FIG. 4 is a schematic of a carrier channel distribution system supporting different configurations of RTUs.

FIG. 5 is a composite image comprising FIGS. 5-1 through 5-4 and presents a more detailed schematic overview of a possible carrier channel distribution system.

FIG. 5-1 is the upper left quadrant of FIG. 5.

FIG. 5-2 is the upper right quadrant of FIG. 5.

FIG. 5-3 is the lower left quadrant of FIG. 5.

FIG. 5-4 is the lower right quadrant of FIG. 5.

FIG. 6 is a composite image comprising FIGS. 6-1 and 6-2 and presents a more detailed schematic overview of a possible host unit.

FIG. 6-1 is the left half of FIG. 6.

FIG. 6-2 is the right half of FIG. 6.

FIG. 7 is a composite image comprising FIGS. 7-1 and 7-2 and presents a more detailed schematic overview of a possible RTU.

FIG. 7-1 is the left half of FIG. 7.

FIG. 7-2 is the right half of FIG. 7.

### DETAILED DESCRIPTION

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable media. For example, a server can include one or more computers operating as a web server, database server, or other type of computer server in a manner to fulfill described roles, responsibilities, or functions. One should appreciate that the disclosed carrier channel distribution system offers several technical effects. One technical effect includes increasing the efficiency of carrier channel allocation to remote locations requiring additional bandwidth.

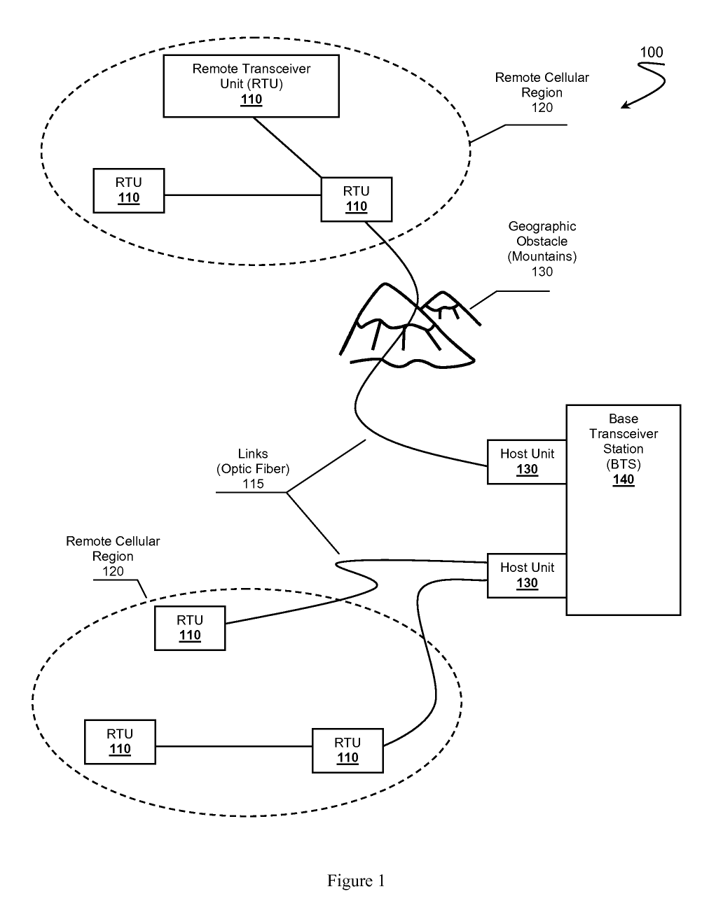

In FIG. 1, carrier channel distribution system 100 is deployed in an environment where cellular regions 120 require wireless coverage. A base transceiver station (BTS) 140 communicatively couples to one or more remote cell regions 120 via one or more host units 130 using physical communication links 115. In a preferred embodiment, a BTS 140 is adapted to transmit and receive digitized signals from carrier channels within one or more bands through a multi-band wireless transceiver. Host units 130 relay digitized signals between BTS 140 and remote transceiver units (RTUs) 110 within the remote cell regions 120 using the physical links 115, preferably fiber optic links. Distribution system 100 can support technologies or protocols including GSM, EDGE, CDMA, TDMA, FDMA, WCDMA, WiMAX, or other wireless technologies.

In a preferred embodiment, the communication links 115 between BTS 140 and remote units 110 employ one or more standards to exchange digitized signals. Suitable standards include those based on the Common Public Radio Interface (CPRI; http://www.cpri.info), the Open Base Station Architecture Initiative (OBSAI; http://www.obsai.org), or other known standards or those yet to be defined.

One should note that the number of elements within contemplated system 100 can vary to match requirements for a communication system. For example, the number of RTUs 110 within a remote region can vary, the number of host units 130 can vary, the number of BTS 140 can vary, or the number of links 115 among the various elements can vary.

In some embodiments, an RTU 110 is geographically separated from BTS 140 by at least 10 Km. It is also contemplated that a single host unit 130 associated with a BTS 140 could link to two or more RTUs 110 that are also geographically separated from each other by at least 10 Km. As used herein “geographically separated” is used euphemistically to represent that two devices are separated by significant distance as opposed to be trivially local to each other. Two devices can be geographically separated by 1 Km, 5 Km, 10 Km, 100 Km, 1000 Km, or further. Indeed such device can be separated across a city, a county, a state, a country, or even separated by continents or oceans. Although the devices can be separated geographically, they preferably communicate over fiber optic links.

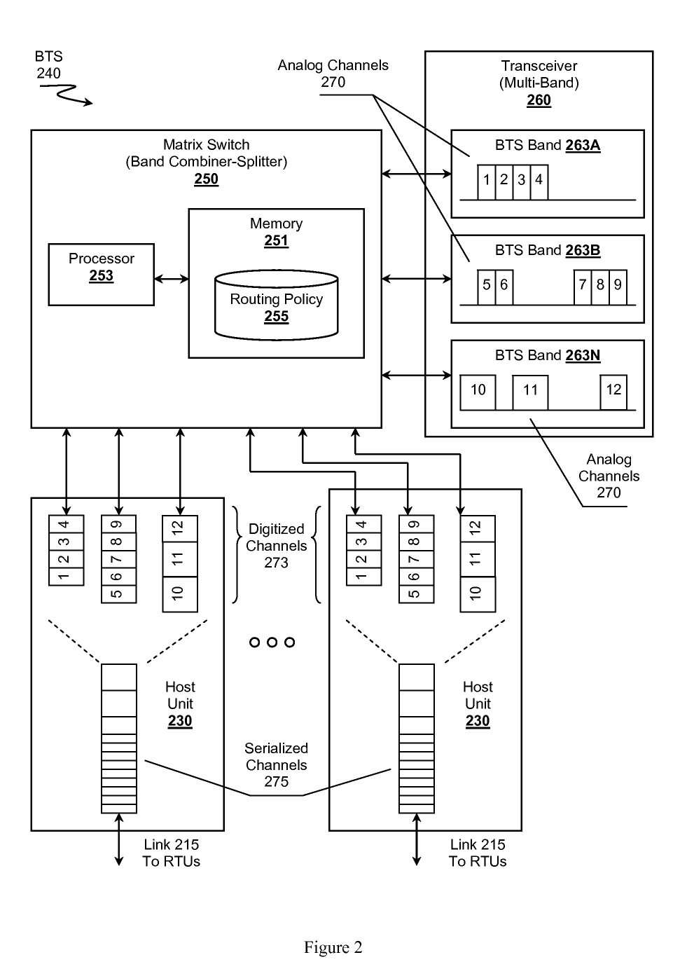

In FIG. 2, BTS 240 is presented in more detail as a schematic of an exemplary embodiment of one aspect of the inventive subject matter. BTS 240 can include multi-band transceiver 260, which is configured to receive a plurality of frequency bands. It is contemplated that a BTS 240 can be coupled to more than one of multi-band transceiver 260, or a single multi-band transceiver 260 can coupled to more than one BTS 240. For discussion purposes only BTS 240 can be considered to comprise multi-band transceiver 260 as illustrated. One should note that alternative configurations are possible while still falling within the scope of the inventive subject matter. For example, each BTS 240 can, itself, be transceiver 260 that is receptive to different bands, or could be remotely coupled to transceiver 260.

Multi-band transceiver 260 is preferably configured to receiver or to transmit wireless signals within a plurality of frequency bands as represented by bands 263A, 263B, through 263N, collectively referred to as bands 263. Each of bands 263 preferably comprises multiple channels as illustrated. For example, band 263A has four active channels; analog channels 270 illustrated as blocks 1-4. Band 263B has five active channels; analog channels 270 illustrated as blocks 5-9, where there is a gap between channels 6 and 7. Band 263N has three active channels; analog channels 270 illustrated as blocks 10-12 where gaps exist between the channels. Preferred bands includes those around 800 MHz, 850 MHz, 900 MHz, 1800 MHz, 1900 MHz, or other frequencies as defined by standards or governing bodies.

The discussion regarding the routing of channels 1-12 from host units to RTUs is presented as channels flowing from transceiver 260, through host units 230, to RTUs. It should be noted that the disclosed system is considered to be bi-directional where carrier channel signals can be received by host units 230 from RTUs, then forwarded to multi-band transceiver 260 or a booster for transmission within bands 263.

Although FIG. 2 illustrates a specific arrangement of analog channels 270 within bands 263, it should be appreciated that the number of channels and their distribution among bands 263 can vary. Furthermore, it should be appreciated that channels 1-12 do not necessarily consume the bandwidth available for their respective bands 263 as represented by the gaps between channels.

Received channels 1-12 from bands 263 are forwarded to matrix switch 250. Matrix switch 250 can operate as a combiner/splitter, preferably an analog combiner/splitter, where bands 263 can have their individual channels 1-12 split into individual channels or groups of channels (e.g., 1-4, 5-6, 7-9, etc.). In a preferred embodiment, matrix switch 250 routes analog channels 270 to an appropriate host unit 230 according to a policy 255 for distribution to remote regions or RTUs. Host units 230 further distribute the channels to RTUs over links 215. As referenced previously, matrix switch 250 can also receive channel signals from host units 230 and can combine the channels back into their proper form for transmission within bands 263 for transmission via multi-band transceiver 260.

As an example, switch 250 could route channel 1 from band 263A to a first host unit 230 while routing channel 2 from band 263A to a second host unit where both channel 1 and 2 originate from the same band. It is contemplated that different carrier channels 270 from different bands 263 can also be treated separately and routed as desired. Such an approach provides for allocating carrier channels 270 to various remote regions to ensure proper coverage given various conditions. Contemplated conditions that could affect coverage include usage, load, weather, events, or other circumstances that could affect how channels are used.

Routing policy 255 can comprises one or more rules that govern behavior of switch 250 with respect to how analog channels 270 should be routed to host units 230 for further distribution to RTUs. Policy 255 is considered to include programmatic instructions stored on a computer readable memory 251 that can be executed within processor 253 that configures switch 250 to properly route the channels.

The rules of policy 255 can operate as functions of one or more metrics available to switch 250. Metrics can be considered to be measures of circumstances associated with matrix switch 250 or its environment, local or global. The rules of policy 255 can include one or more criterion representing a trigger for an action that should be taken when the metrics satisfy the criteria of the rules. When the criteria are met, matrix switch 250 can take appropriate routing action.

Metrics include observed metrics, set metrics, calculated metrics, or other types of parameters or attributes of the system. Observed metrics are considered to be those having values that are measured by BTS 240, matrix switch 250, or other device associated with the system. Example observed metrics include a time (e.g., absolute, relative, date, etc.), a rate, a threshold, a quantity, a count, or other type of data that is measurable. It is contemplated that some metrics can include historical information relating to the system. Set metrics are considered to be parameters that have set values possibly comprising a geo-location of BTS 240 or RTUs, a flag, an authorization token or password, or other parameter that likely remains static unless directed to change by an authorized user. A calculated metric is considered to be a metric that has a value, or multiple values, as derived from a function operating on other metrics. Example, calculated metrics can include a traffic rate, a consumed bandwidth, an aggregated count, or other derived metrics.

As an example, consider a policy 255 that has rules governing the use of bandwidth allocated to different remote regions. A first region might have a significant number of commercial businesses that require additional bandwidth during business hours. The first region could be allocated a large number of channels during the business hours while a residential region might have a smaller number of channels during the same time frame. In such an embodiment, channels 270 can be routed, distributed, or allocated based on time-based metrics using simple rules.

Another example includes a policy 255 that routes, allocates, or distributes channels based on a current traffic load. Processor 253 can be configured to analyze traffic metrics (e.g., data rate, call rate, consumed bandwidth, etc.) and correlate various metrics with a signature of potential traffic issues, load balancing for example. If the current or recent historical traffic metric have a profile that satisfies criteria of a signature for a triggering condition, switch 250 can route, allocate, or distribute channels as defined by policy 255 to balance traffic load.

One aspect of the inventive subject matter is considered to include establishing one or more signatures of desirable triggering criteria. A signature can be represented by a plurality of metric values, either static value or time-varying vales, and relationships among the metric values. The relationships among metrics can include logical operates (e.g., AND, OR, XOR, etc.), programmatic instructions, threshold criteria, variances around average trends, or other types of relationship. Such signatures can be supplied to matrix switch 250 as part of policy 255.

Yet another example includes a policy 255 that distributes or allocates channels to remote regions based on events. An event can include weather events, political events, trade shows, sporting events, government or police requests, emergencies, or other types of events outside the scope of BTS 240. Allocating channels to remote regions based on events ensures that sufficient service coverage is available as conditions change. For example, if a weather disaster occurs, switch 250 can be instructed to allocate more channels to a victim region to increase the bandwidth available to victims or aid workers. Such an embodiment can be achieved through setting values to metrics (e.g., flags, Booleans, etc.) that indicate an event is taking place. It is also contemplated that allocating channels based on event could be achieved through a scheduled time as would be possible in a sporting event scenario.

Policy 255 can be configured to route, distribute, or allocate channels 270 collectively, as groups, individually, or in other desirable configurations. Matrix switch 250, based on policy 255, can allocate a first carrier channel to a first RTU while a second carrier channel from the same band can be routed to a second RTU. For example channel 1 from band 263A could be routed as an individual, separate from channels 2-4 from band 263A. Channels 5 and 6 could be grouped and routed together to an RTU, or could be split. Furthermore, individual channels from different bands could be split from their bands, and combined together. For example, channel 3 from band 263A could be combined with channel 12 from band 263N, which can then be routed together to an RTU as a group.

In more preferred embodiments, policy 255 is reconfigurable. A policy is considered reconfigurable if it can be externally updated or modified to reflect changes in its rules as opposed to having a static set of rules that are unchanging. Policy 255 can be reconfigured through numerous means. In some embodiments, BTS 240 or even matrix switch 250 include a network interface, through which policy 255 can be updated after required authentication or authorization. Matrix switch 250 could pull a new policy 255 from a remote server or a remote server or a user could push a new policy 255 to memory 251. Policy 255 can be reconfigured by adding new rules, modifying existing rules, removing older rules, defining new metrics, setting metrics, or taking other management actions. It is also contemplated that more than one policy 255 could be updated across multiple BTS 240 spread over geographic regions. It is also contemplated that policy 255 could be reconfigured by physically replacing memory 251 storing policy 255 (e.g., flash card, hard drive, solid state driver, etc.).

Each host unit 230 can couple to switch 250 to send or receive channel signals. In a preferred embodiment, the host units 230 are configured to optimally digitize desirable channels as opposed to a complete band. For example with respect to illustrated band 263B, a host unit can digitize, using an Analog to Digital Convert (ADC), a portion of band 263B that is less than the full width of the band represented by the underline and that only corresponds to an envelope around one or more carrier channels (e.g., an envelope around channels 5 and 6 and/or an envelope around channels 7-9). Additionally, host unit 230 preferably filters out unused white space within bands 263 to reduce bandwidth utilization on links 215 between host units 230 and RTUs. Host units 230 preferably serialize digitized channels 273 and sends the digitized data over communications links to one or more RTUs. As shown all of channels 270 are transformed into serialized channels 275. One should appreciate, as discussed previously, channels 270 can be routed or allocated according to policy 255 individually, collectively as shown, or in arbitrary groups. Serialized channel 275 can then be sent to the RTUs over links 215. As previously discussed, preferred links 215 utilize a standard for exchanging data on channels 273 (e.g., CPRI, OBSAI, etc.). One should appreciate that host unit 230 can operate bi-directionally where it can received serialized channels 275 from an RTU, de-serialize the channels back into digitized channel 273, restore analog channels 270, and send the signals of the channels back to switch 250 within their proper channels 270. It should be appreciate that digitizing or serializing carrier channels is considered to include digitizing or serializing data carried by the channels as desired.

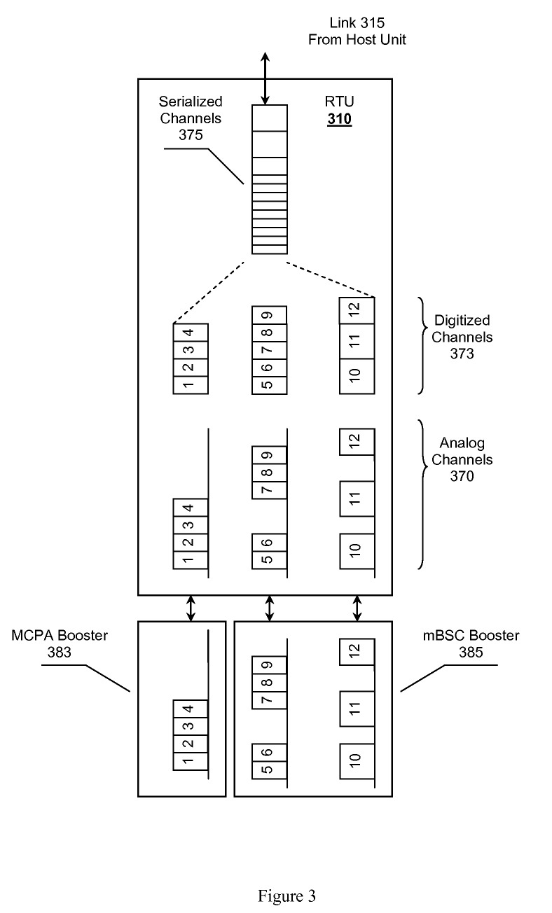

In FIG. 3, RTU 310 receives serialized channels 375 from a host unit over link 315. RTU 310 employs a reverse process as taken by host units with respect standards for exchanging data on carrier channels (e.g., CPRI, OBSAI, etc . . . ). RTU 310 de-serializes serialized channels 375 to obtain digitized channels 373. Digitized channels can be converted back into analog channels 370 using suitable Digital to Analog Converters (DAC). Channels 370 can then be distributed to one or more boosters for re-transmission as represented by MCPA booster 383 or mBSC booster 385. Suitable boosters include those produced by Bravo Tech Inc, of Cypress Calif. For example, the Bravo Tech Multi-Channel Power Amplifier (MCPA) series of products or Bravo Tech Multi-Band, multi-Standard & multi-Carrier (mBSC) systems can be deployed in the contemplated environments, including indoor or outdoor environments. The channels 370 can be allocated to the boosters as desired: one band per booster, two bands per booster, etc.

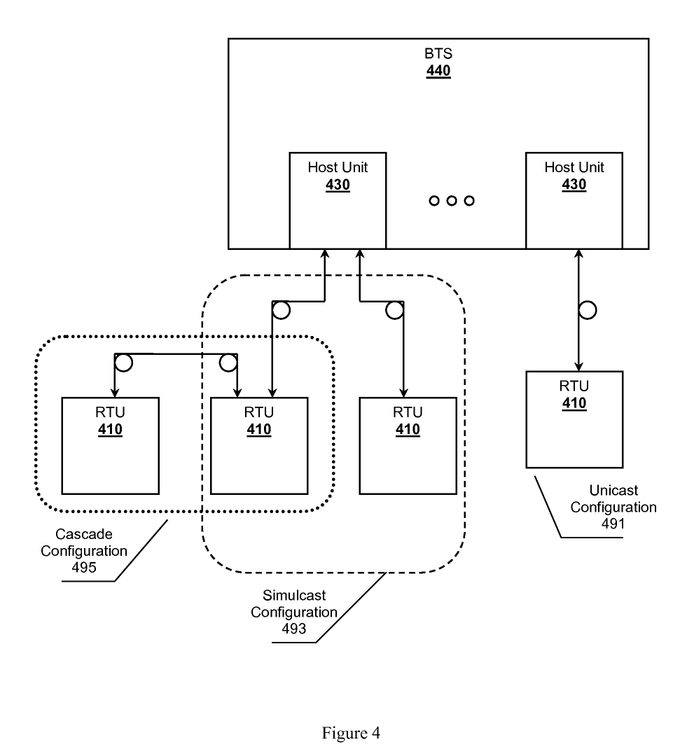

In FIG. 4, RTUs 410 are arranged into different carrier channel distribution configurations. BTS 440 comprises two of host unit 430, which route carrier channels to one or more of RTUs 410. Configurations can include one-to-one couplings, one-to-many couplings, or even many-to-many couplings if an applications calls for such a configuration. Unicast configuration 491 represents a configuration where a single host unit 430 couples to a single RTU 410 at a remote location. Such a configuration represents a one-to-one configuration. Simulcast configuration 493 represents a configuration where a single host unit 430 couples to more than one RTU 410 in a one-to-many configuration. A single host unit 430 can duplicate serialized carrier channels as necessary and send the serialized data over more than one fiber optic link to multiple RTUs 410. One should note that in a simulcast configuration 493, multiple RTUs 410 could be in the same remote region or in different remote regions. Cascade configuration 495 also represents a one-to-many configuration where a host unit 430 couples to an RTU 410, which in turn cascades the serialized carrier channels to another RTU 410, preferably over another optic link. Cascade configuration 495 can include RTUs 410 within a single remote region or can be spread among multiple remote regions.

The illustrated examples in FIG. 4 presents a few of many possible configurations. It is also contemplated that multiple host units 430 could connect to a single RTU 410 in a many-to-one configuration. Such embodiments can provide for redundancy of connectivity should one of BTS 440 fail, possibly due to a natural disaster.

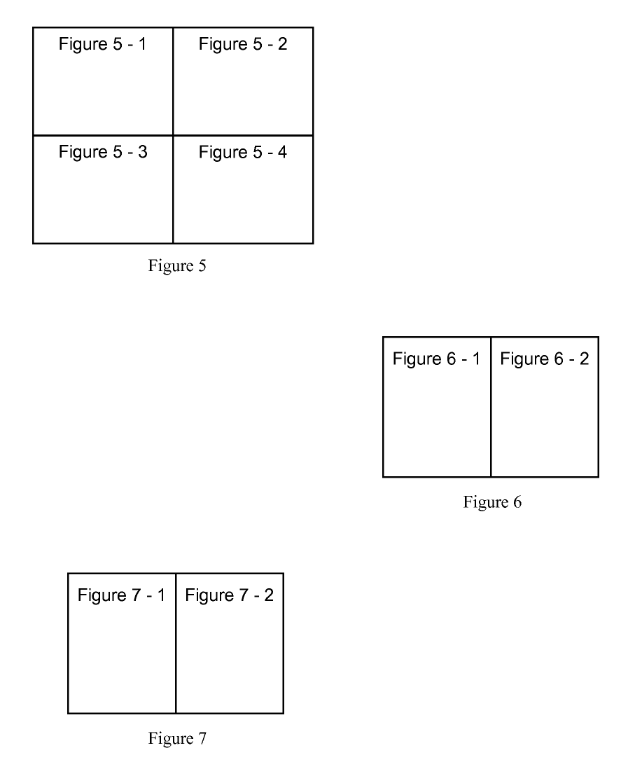

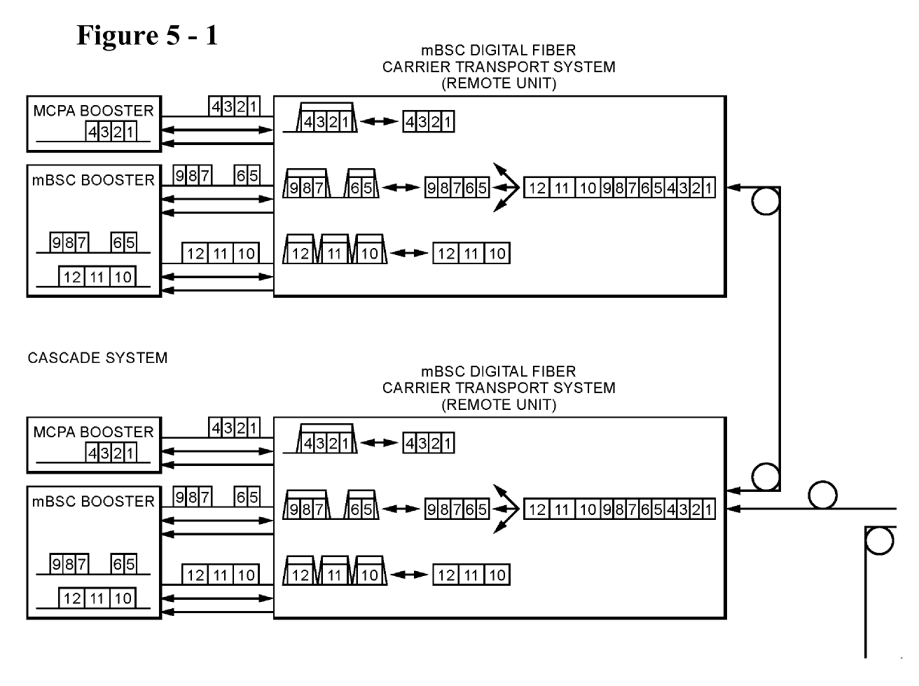

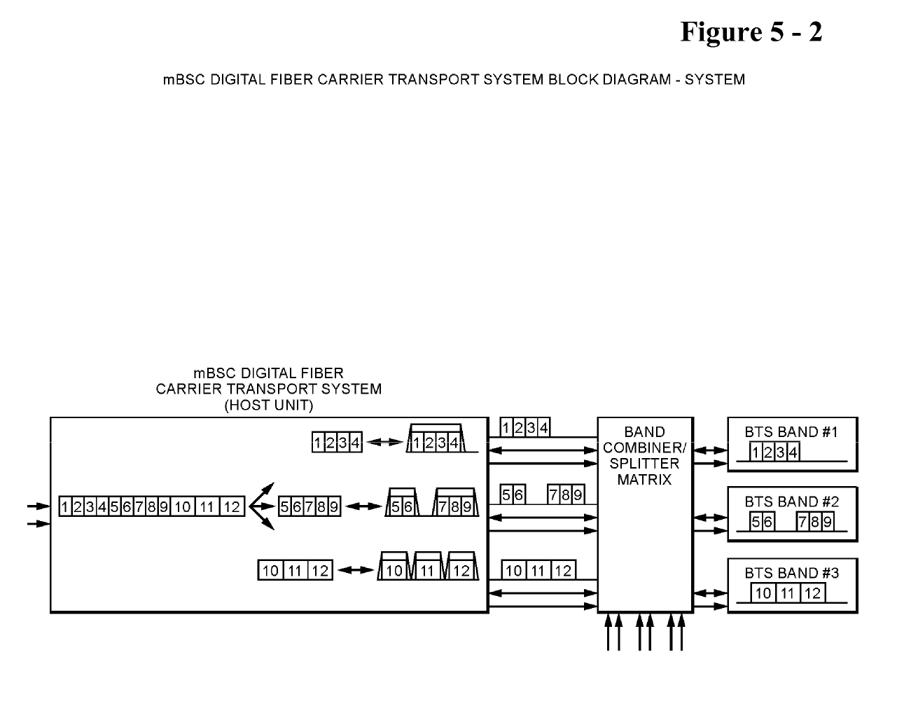

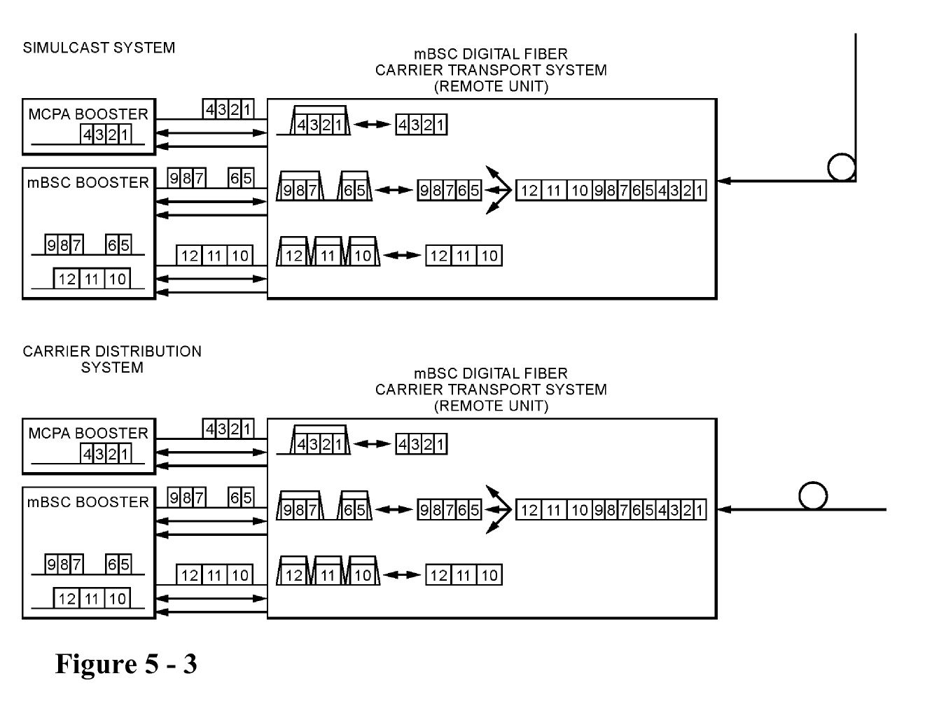

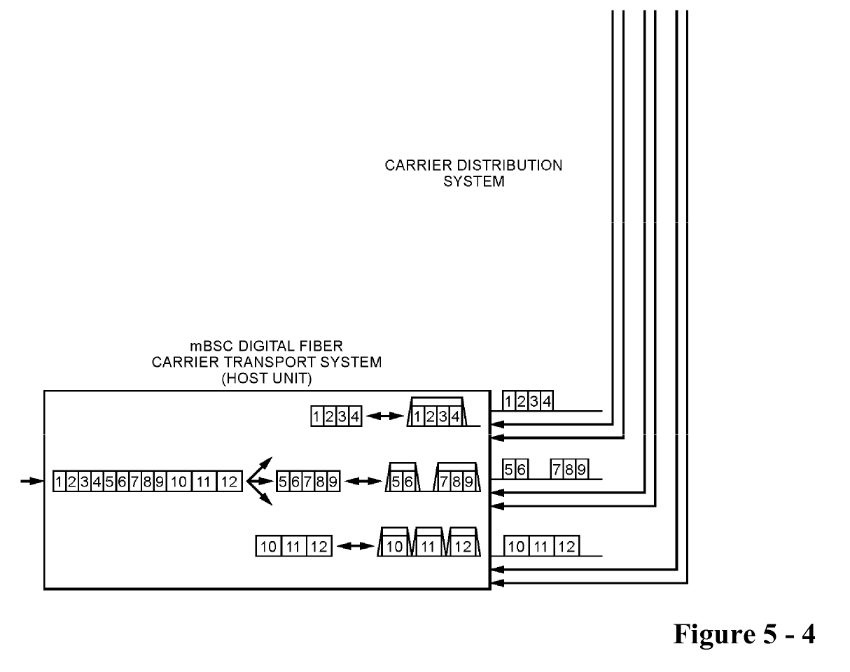

FIGS. 5, 6, and 7 are composite images comprising other figures as discussed below. FIGS. 5, 6, and 7 illustrate the relationship of the remaining figures relative to each other.

FIG. 5 is a composite image of FIGS. 5-1, 5-2, 5-3, and 5-4 and presents a more detailed schematic of a possible carrier channel distribution system where a matrix switch operating as a band combiner/splitter routes channels to one or more RTUs via a BTS's host units. The channels can be digitized using an ADC individually or as a group within an envelope as shown. The digitized channels and their encapsulated data can then be sent as a serialized stream to the RTUs, where the streams are de-serialized and converted back to analog signals for presentation to boosters.

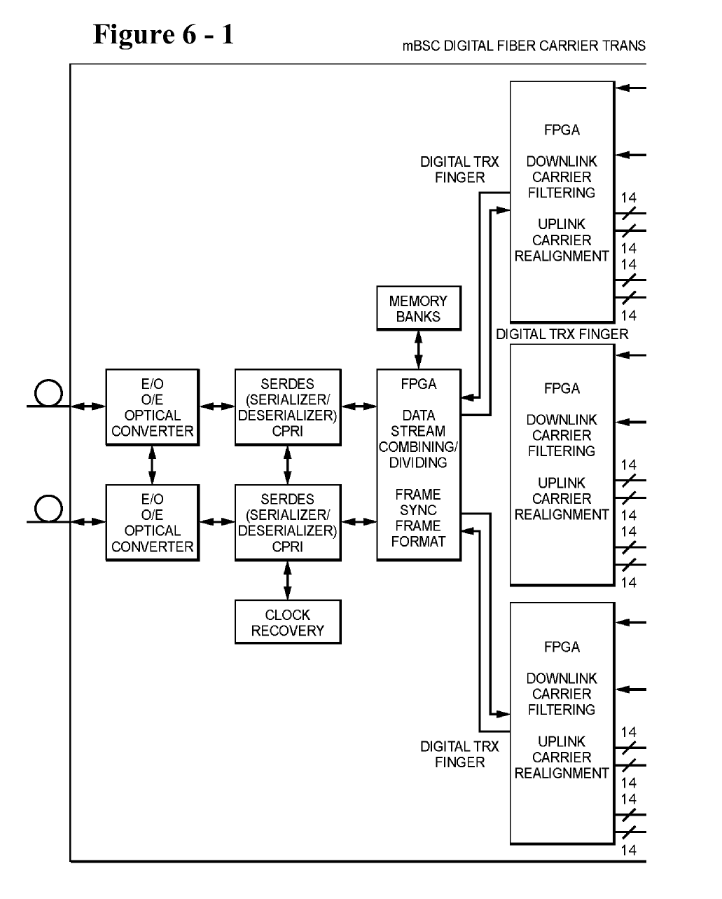

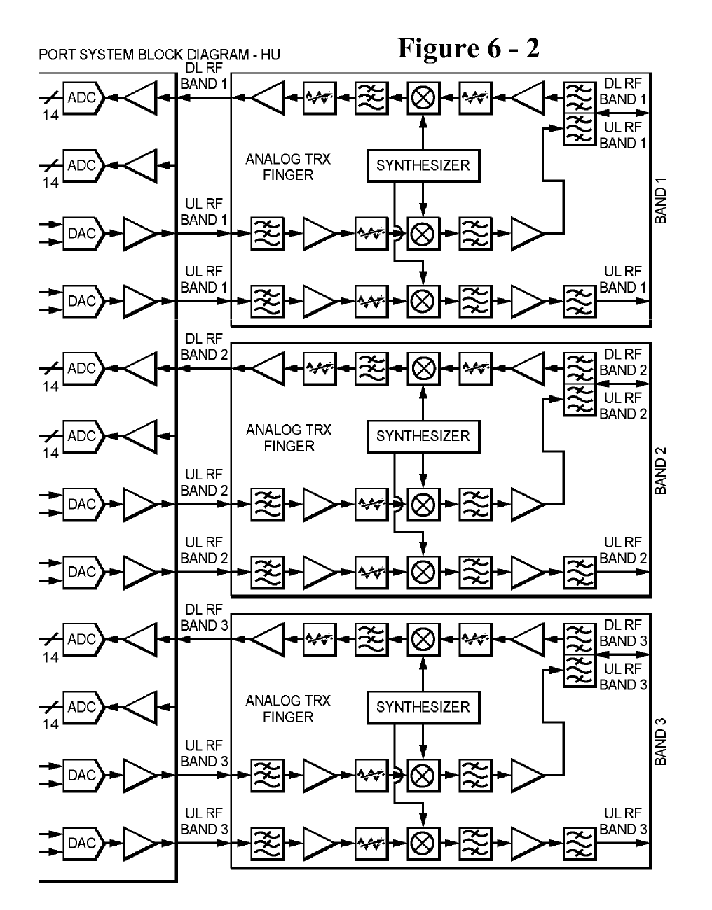

FIG. 6 is a composite image of FIGS. 6-1, and 6-2 and provides a possible schematic of a host unit employing one or more FPGAs. FPGAs can be configured to communicate with a matrix switch to obtain signals from the respective bands supported by the system. An FPGA can also be used to frame, combine, divide, synchronize, or otherwise manage the carrier channels. In the example shown, the carrier channels are serialized using a CPRI standard.

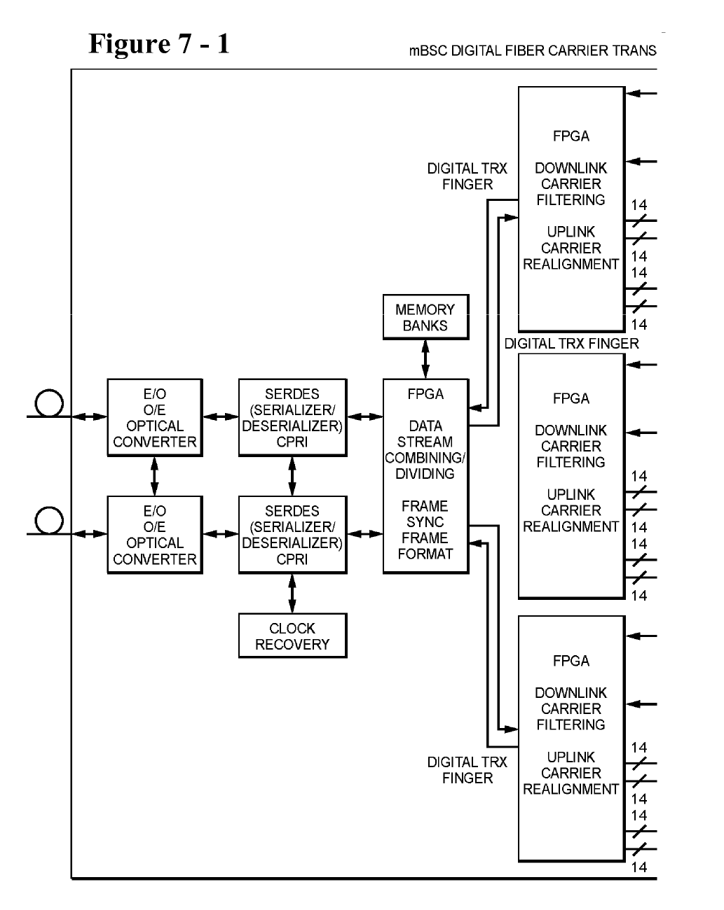

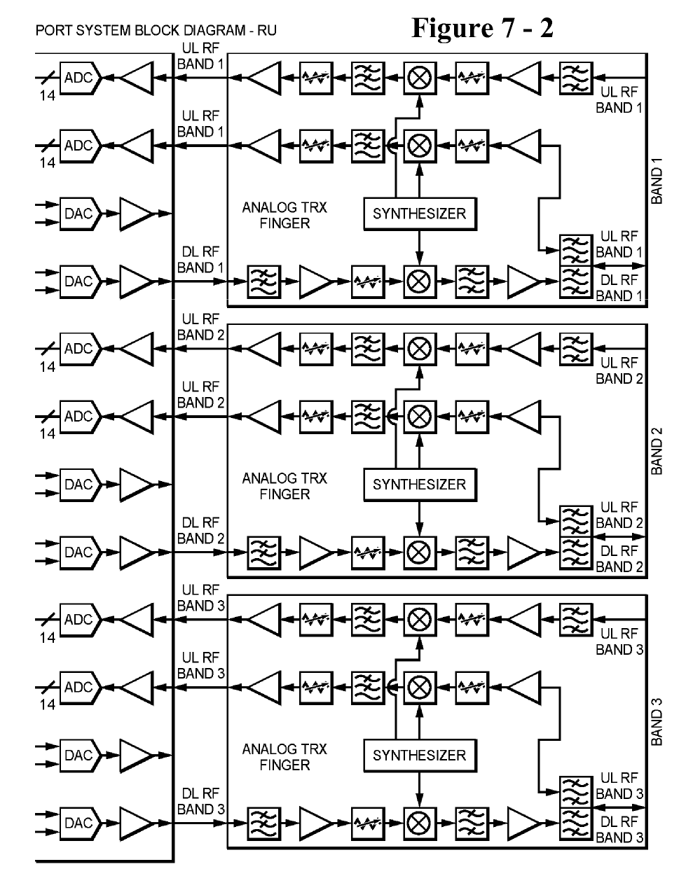

FIG. 7 is a composite image of FIGS. 7-1, and 7-2 and provides a possible schematic of an RTU having similar structure of the host unit of FIG. 6 and that mirrors a host unit's functionality. As mentioned previously, contemplated system can be bi-directional in nature.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A carrier channel distribution system, comprising:
a multi-band transceiver capable of receiving a first band and a second band where each band includes a plurality of carrier channels;
a multi-band matrix switch coupled to the multi-band transceiver;
a first and a second host unit coupled to the matrix switch and where the first host unit is coupled to a first remote unit and the second host unit is coupled to a second, different remote unit; and
wherein in the matrix switch is configured to (a) route a first carrier channel of the plurality of carrier channels from the multi-band transceiver to the first remote unit and (b) route a second carrier channel of the plurality of carrier channels from the multi-band transceiver to the second remote unit, where the matrix switch is configured to route the channel according to a reconfigurable routing policy.

2. The system of claim 1, wherein the first host unit is geographically separated from the first remote unit.

3. The system of claim 2, wherein the first remote unit and the second remote unit are geographically separated.

4. The system of claim 1, wherein the matrix switch comprises an analog band combiner/splitter.

5. The system of claim 1, wherein the first host unit couples to the first remote unit via an optic fiber connection.

6. The system of claim 1, wherein the first host unit couples to a plurality of remote units.

7. The system of claim 6, wherein the plurality of remote units form a simulcast configuration.

8. The system of claim 6, wherein the plurality of remote units from a cascade configuration.

9. The system of claim 1, wherein the first and the second carrier channels originate from the same band.

10. The system of claim 9, wherein the matrix switch is configured to allocate the first carrier channel to the first remote unit and the second carrier channel to the second remote unit for a time period according to the policy.

11. The system of claim 10, wherein the matrix switch is configured to automatically allocate the carriers channels according to the policy.

12. The system of claim 10, wherein the policy includes load balancing rules.

13. The system of claim 10, wherein the policy includes event based rules.

14. The system of claim 1, wherein the multi-band transceiver comprises at least two transceivers where each of the transceivers operates on a different band.

15. The system of claim 1, wherein the first host unit is adapted to digitize a portion of the first band that is less than the full width of the band.

16. The system of claim 15, wherein the portion of the first band envelopes a set of carrier channels within the band.

17. The system of claim 15, wherein the first host unit is further adapted to filter out white space within the band.

18. The system of claim 15, wherein the first host unit is further adapted to serialize the portion of the first band with other digitized portions from other bands.
